(19) United States
(12) Patent Application Publication
(10) Pub. No.: US 2010/0189872 A1
(43) Pub. Date: Jul. 29, 2010

(54) UNRIPE ESSENTIAL OIL WITH ENHANCED STABILITY AND USABILITY AND METHOD FOR PRODUCING SUCH OIL

(75) Inventors: Ad S. OLANSKY, Decatur, GA (US); Ling LU, Atlanta, GA (US); Jimmy L. ARNETT, Douglasville, GA (US); Sheng Sheng YANG, Marietta, GA (US); Christopher J. SMITH, Atlanta, GA (US); Dennis R. RYAN, Marietta, GA (US); Terence RADFORD, Atlanta, GA (US)

Correspondence Address: THE COCA-COLA COMPANY;PATENT & TECHNOLOGY DEPT--NAT 19, P. O. BOX 1734, ATLANTA, GA, 30301, US

(73) Assignee: THE COCA-COLA COMPANY, Atlanta, GA (US)

(21) Appl. No.: 12/751,021

(22) Filed: Mar. 31, 2010

Related U.S. Application Data
(63) Continuation-in-part of application No. PCT/US09/48643, filed on Jun. 25, 2009.
(60) Provisional application No. 61/077,015, filed on Jun. 30, 2008.

(51) Int. Cl. A23L 1/222; A23L 1/221; A23L 1/27

(52) U.S. Cl. 426/651; 426/422; 426/424

(57) ABSTRACT

Methods for enhancing the stability and shelf lives of unripe essential oils without substantially changing the organoleptic properties other than color of the unripe essential oils are described. The methods involve obtaining an unripe essential oil with a first amount of chlorophyll, contacting the unripe essential oil with an activated carbon to produce a treated essential oil with a second amount of chlorophyll that is less than the first amount of chlorophyll, and separating the treated essential oil from the activated carbon.

### RELATED APPLICATION DATA

The present application is a continuation-in-part, under 35 U.S.C. §111(a), of International Application No. PCT/U.S.09/48643, entitled “Essential Oil Processing,” filed on Jun. 25, 2009, which claims priority to U.S. Provisional Patent Application No. 61/077,015 of the same title, filed on Jun. 30, 2008, the entire contents of all of which are incorporated by reference herein.

### BACKGROUND

Essential oils are volatile oils derived from at least a part of a plant such as fruit peels and leaves, stems, flowers, bark, roots, or twigs. Essential oils usually carry the natural odor or flavor of the plant or its fruit and are thus used in the preparation of products including foods, beverages, perfumes, pharmaceuticals, air fresheners, aromatherapeutics, and cosmetics. Such oils may be extracted by various methods that release the oils from the plant structures containing them. For example, citrus oils may be derived by squeezing or pressing citrus fruit peels.

Essential oils may be extracted from fruits at various stages of ripeness. Depending on the type and/or origin, some unripe fruits tend to have a green coloring due to the dominant presence of chlorin-based pigments such as chlorophyll. Chlorophyll absorbs strongly in the blue and red sections of the electromagnetic spectrum, but it absorbs weakly in the green section, hence imparting a green color to chlorophyll-containing tissues such as plant leaves and unripe fruit peels. Consequently, essential oils extracted from some unripe fruits may have a green coloring. As fruits ripen, their acidities change and the pigments change, transforming the fruits into a more yellowish and/or red coloring. For example, mandarin oranges are greenish when they are unripe. Maturing mandarins, however, contain dominant yellow and red carotenoid pigments that give a yellowish tint. As the mandarins fully ripen, the red pigments become more dominant so that the ripe fruits have more of a reddish glow.

As used herein, the term “plant source” means any part of a plant or the whole plant. As used herein, “unripe essential oil” means any essential oil extracted from an unripe fruit, which may or may not be associated with a green coloring depending on the plant source of the oil. As used herein, “ripe essential oil” means any essential oil extracted from a ripe fruit, which may or may not be associated with a yellow or red coloring depending on the plant source.

As used herein, the term “organoleptic property” means any property associated with one or more of the organs of sense, i.e. taste, smell, touch. Some examples of organoleptic properties include but are not limited to texture, viscosity, taste, odor, and appearance. As used herein, the term “shelf life” means the period of time that an essential oil or a product containing an essential oil may be stored with at least intermittent exposure to artificial or natural light without a substantial change in an organoleptic property.

Unripe essential oils are often less expensive and more readily available than ripe essential oils. They also may contain fewer pesticides and other agricultural contaminants because unripe fruits are less prone to insect attacks and the effects of spoilage organisms. Despite these advantages, unripe essential oils are not as widely used as ripe essential oils, especially in foods and beverage applications. One reason is because products containing unripe essential oils tend to have shorter shelf lives than products containing ripe essential oils from the same plant source. For example, inventors of the present invention discovered through sensory tests that when beverages containing unripe mandarin oils were stored under artificial light, they were much more likely and quickly to develop off-tastes than beverages containing ripe mandarin oils that were stored under the same light conditions. Analytical data of the different beverages suggested that chlorophyll in the unripe mandarin oil accelerated the conversion of gamma terpinene to para-cymene under light. The elevated level of para-cymene and the reduced level of gamma terpinene consequently caused changes in the taste and the odor of the beverage, effectively reducing the shelf life of the beverage.

In addition to the shortened shelf life, an excessive amount of chlorophyll may impart an undesirable green tint to the final product depending on the applications. Therefore, it would be desirable to remove at least some of the chlorophyll from the unripe essential oils to improve their stability and overall usability, especially as substitutes for ripe essential oils. It would be further desirable if removing at least some of the chlorophyll would not significantly alter any organoleptic property of the essential oil that is preferred for the selected applications. Depending on the applications, it may also be desirable to remove a component other than chlorophyll from the unripe essential oil, especially if the component may be recovered for use elsewhere.

Other objects, features, and advantages of this invention will become apparent from the following description, examples, and claims.

### DETAILED DESCRIPTION

Particular embodiments of the present invention encompass a method for enhancing the stability and usability of an unripe essential oil without substantially changing an organoleptic property other than color of the unripe essential oil, comprising obtaining an unripe essential oil derived from a plant source, wherein the unripe essential oil comprises a first amount of chlorophyll, contacting the unripe essential oil with an effective amount of an activated carbon to produce a treated essential oil, and separating the activated carbon from the treated essential oil. Preferably, the treated essential oil comprises a second amount of chlorophyll that is less than the first amount of chlorophyll. Alternatively, the treated essential oil may be substantially free of chlorophyll. Embodiments of the present invention also encompass a first edible product comprising the treated essential oil. Preferably, the shelf life of the first edible product may be similar to the shelf life of a second edible product, wherein the second edible product comprises a ripe essential oil derived from the same plant source. The term “similar” as used herein is intended to also encompass identical comparisons.

The effective amount of the activated carbon depends on multiple factors including but not limited to the plant source of the unripe essential oil, the degree of ripeness of the plant source, the origin of the plant source, the growth conditions of the plant source, the volume of the unripe essential oil, the intended application of the treated essential oil, and the amount of chlorophyll in the unripe essential oil.

In particular embodiments of the present invention, the effective amount of the activated carbon may be at least a minimum, wherein the minimum is the lowest amount needed to make the shelf life of the treated essential oil similar to the shelf life of a ripe essential oil derived from the same plant source. One skilled in the art may determine the shelf life of an essential oil and/or a product utilizing an essential oil by various methods of detecting a change in any organoleptic property of the essential oil and/or product. Examples of such methods include but are not limited to sensory testing, spectrometry measurements, electronic nose/tongue measurements, and chromatography.

Inventors of the present invention unexpectedly discovered that activated carbon has a tendency to selectively adsorb chlorophyll over most of the other components in the unripe essential oil and the oil itself. This selectivity is particularly useful for applications that exploit the natural flavors, fragrances, and/or other properties of the unripe essential oil so that components responsible for such desired properties are not substantially removed prior to or at the same time as the removal of chlorophyll. As used herein, the term “desirable component” means any component in the unripe essential oil responsible for any desirable physical and/or organoleptic property in the essential oil and/or in the products containing such oil. As used herein, the term “threshold amount” means the amount of a desirable component at which, if removed from the unripe essential oil, may substantially change any desirable physical and/or an organoleptic property in the essential oil and/or in the products containing such oil.

Despite the activated carbon's preferred adsorption of chlorophyll, once most of the chlorophyll has been adsorbed, any remaining activated carbon may begin absorbing other components. Consequently, too much activated carbon may result in the loss of one or more of the desirable components; excess carbon also entrains more of the essential oil, thereby reducing the overall oil yield from the treatment method. In an alternative embodiment of the present invention, the effective amount of the activated carbon may be less than a maximum, wherein the maximum is the amount beyond which the activated carbon adsorbs more of the unripe essential oil and/or a desirable component than the first amount of chlorophyll. Alternatively, the maximum is the amount necessary to remove at least about 70% of the first amount of chlorophyll in the unripe essential oil. Preferably, the maximum is the amount necessary to remove substantially all of the first amount of chlorophyll. Alternatively, the maximum may be the amount necessary to remove at least about 50% of the first amount of chlorophyll without removing a threshold amount of a desirable component. One skilled in the art may readily determine the maximum by various methods including but not limited to visual observation and measurements of chlorophyll, oil, and/or a desirable component either adsorbed on the activated carbon or remaining in the oil.

As previously explained, chlorophyll in essential oils catalyzes the conversion of gamma terpinene to para-cymene when stored under natural or artificial light. As used herein, the term “PC/GT Ratio” means the ratio of para-cymene to gamma terpinene. A higher PC/GT Ratio would indicate that there has been more conversion of gamma terpinene to para-cymene. As used herein, the term “Conversion Rate” means the ratio of an essential oil's (or product containing the essential oil)'s PC/GT Ratio at day 25 to the PC/GT Ratio at day 2 when the essential oil or the product containing the essential oil has been at least intermittently stored under natural or artificial light. A higher Conversion Rate would correlate with a faster rate of conversion from gamma terpinene to para-cymene.

Alternative embodiments of the present invention encompass a method of extending the shelf life of a first edible product comprising an essential oil, comprising obtaining an unripe essential oil derived from a plant source, wherein the Conversion Rate of the unripe essential oil may be at least about 3.0, contacting the unripe essential oil with an effective amount of an activated carbon to produce a treated essential oil, wherein the Conversion Rate of the treated essential oil may be less than about 2.5, separating the activated carbon from the treated essential oil, and utilizing the treated essential oil in the first edible product. Preferably, the Conversion Rate of the treated essential oil may be less than about 2.0. More preferably, the Conversion Rate of the treated essential oil may be less than about 1.5. Alternatively, the Conversion Rate of the first edible product may be similar to the Conversion Rate of a second edible product comprising a ripe essential oil derived from the same plant source.

Preferably, the unripe essential oil comprises a first amount of chlorophyll and the treated essential oil comprises a second amount of chlorophyll, wherein the second amount of chlorophyll may be less than the first amount of chlorophyll. Alternatively, the treated essential oil may be substantially free of chlorophyll.

One skilled in the art may determine the Conversion Rate of an edible product containing an essential oil by various analytical methods including but not limited to purge/trap gas chromatography-mass spectrometry (GC/MS), headspace GC/MS, solid phase microextraction GC/MS, and purge/trap gas chromatography-flame ionization detector.

Essential Oils
a. In some embodiments of the present invention, the unripe essential oil may be a citrus oil. Citrus oils suitable for use with the embodiments of this invention include lemon oil, orange oil, lime oil, grapefruit oil, tangerine oil, mandarin oil, bitter orange oil, and bergamot oil. Preferably, the citrus oil may be a mandarin oil. More preferably, when the unripe essential oil is a mandarin oil, the effective amount of the activated carbon may be at least 5 wt % of the mandarin oil. Even more preferably, the effective amount of the activated carbon may be less than about 13 wt % of the mandarin oil. Although embodiments of this invention are particularly effective in selectively removing components from citrus oils, they may also be used for other essential oils including but not limited to, peel oils, leaf oils such as mint oils, spice oils such as clove oil, flower oils such as rose oil, and other plant oils.
b. Essential oils may be derived or extracted from whole fruit or portions thereof using available equipment and known methods including but not limited to cold-pressing and machine abrasion techniques. In cold-pressing and machine abrasion processes, the plant source is manipulated to help release the oil and then pressed or otherwise manipulated to help remove the oil from the plant material. The oil may then be separated from the plant material by methods such as centrifugation, filtration, decanting, distillation, and solvent extraction.

Chlorophyll
a. In preferred embodiments of the present invention, the second amount of chlorophyll may be substantially less than the first amount of chlorophyll. For example, the second amount of chlorophyll may be at least about 50% less or at least about 70% less or at least about 90% less than the first amount of chlorophyll. One skilled in the art may readily determine the first and second amount of chlorophyll by such methods including but not limited to visual assessment, liquid or gas chromatography, sensory testing, thin-layer chromatography, nuclear magnetic resonance (NMR) spectroscopy, and UV-Vis spectrophotometry.

Activated Carbon
b. Activated carbon used in the present invention may be obtained from commercial sources such as Carbon Activated Corporation (Orchard Park, N.Y.) and Mead/Westvaco (Glen Allen, Va.). Examples include but are not limited to Mead/Westvaco's Nuchar® SA-20 and Nuchar® SN-20. The activated carbon may be utilized by any method that ensures intimate contact between the activated carbon and the unripe essential oil. For example, the unripe essential oil and an activated carbon may be combined in a mixer to form a slurry. After a predetermined period of time that allows the chlorophyll or a selected component to be adsorbed by the activated carbon, the treated essential oil may be separated from the activated by various methods including but not limited to filtration, sedimentation and centrifugation.

In another example, the unripe essential oil may be treated by passing it through a column containing the activated carbon. When a column is used, the unripe essential oil may be injected or poured onto the column and the treated essential oil may be eluted from the column, optionally, under pressure. Such methods may be performed in batch or continuous modes with replacement or regeneration of the activated carbon as needed.

One skilled in the art may readily select the type and form of carbon suitable by considering factors including but not limited to type of equipments, process mode, and specifications of the activated carbon such as particle size, porosity, and surface area. For example, powdered carbon may be more suited in batch modes while granular carbon may be more suited in column applications. 2000 m²/g. Preferably, the activated carbon may have a surface area between about 1400 m²/g and about 1800 m²/g.

In addition to the activated carbon, other adsorbent materials may be used, including but not limited to amorphous silicas, bleaching earth, fuller's earth, and diatomaceous earth (alternately known as diatomite, diahydro, kieselguhr, kieselgur and celite). One skilled in the art may determine the preferred adsorbent material with routine experimentation while considering factors including but not limited to the type of adsorbent material, its characteristics, the type of unripe essential oil, and the desired applications for the treated essential oil.

Extracting Additional Components from Unripe Essential Oils

In addition to chlorophyll, the activated carbon (and/or another adsorbent material) may be used to extract other components (desirable or not) in the unripe essential oils, some of which may be separated from the activated carbon and used in other applications. Particular embodiments of the present invention encompass a method for extracting a component from an unripe essential oil, comprising obtaining an unripe essential oil, wherein the unripe essential oil comprises at least one component, contacting the unripe essential oil with an effective amount of an activated carbon to produce a treated essential oil, wherein the at least one component is adsorbed by the activated carbon, and separating the activated carbon from the treated essential oil. Preferably, the at least one component may be selected from a chlorophyll, a flavonoid, and a desirable component. More preferably, the method comprises recovering the at least one component from the activated carbon. Even more preferably, the method further comprises utilizing the at least one component recovered from the activated carbon in an edible product.

In some embodiments, the at least one component may be a flavonoid. Preferably, the method comprises recovering the flavonoid from the activated carbon with a polar solvent. The polar solvent may be selected from an acetone, an ethanol, and a dichloromethane. Alternatively, the method further comprises washing the activated carbon with a nonpolar solvent prior to recovering the flavonoid from the activated carbon.

In other embodiments, the at least one component may be a desirable component and the effective amount of the activated carbon may be less than a maximum, wherein the maximum is the amount necessary to remove a threshold amount of the desirable component. Preferably, the method comprises recovering the desirable component from the activated carbon with a polar solvent. Alternatively, the method further comprises washing the activated carbon with a nonpolar solvent prior to recovering the desirable component from the activated carbon.

In addition to the factors previously mentioned for determining the effective amount of the activated carbon for other embodiments, one skilled in the art may also consider additional factors such as the amount of the component desired to be removed from the unripe essential oil, the adsorption efficiency, and the degree of difficulty or costs or time for recovering the component from the activated carbon. Similar to the detection and measurement of chlorophyll, one skilled in the art may readily determine the amount of the component adsorbed by the activated carbon or the amount of the component in the unripe essential oil and/or the treated essential oil by various methods including but not limited to visual assessment, sensory testing, liquid or gas chromatography, UV-Vis spectrophotometry.

Depending on the desired applications and/or the availability of equipments, time, space, and other factors, embodiments of the present invention may encompass a one-stage treatment method comprising removing a first predetermined amount of the chlorophyll and a second predetermined amount of a component other than chlorophyll with an effective amount of activated carbon. Alternatively, embodiments of the present invention may encompass a two-stage treatment method comprising removing a first predetermined amount of the chlorophyll with an effective amount of a first activated carbon and then removing a second predetermined amount of a component other than chlorophyll with an effective amount of a second activated carbon or another suitable adsorbent material. Multi-stage treatments may also be set up if more than one component other than chlorophyll is desired to be removed from the unripe essential oil.

The first activated carbon and the second activated carbon may be the same activated carbon if the first activated carbon comprising the chlorophyll would be effective in adsorbing the second predetermined amount of the component other than chlorophyll. Another advantage of the present invention is that the chlorophyll adsorbed by the activated carbon is not easily extracted from the activated carbon. Hence, the same activated carbon may be used to adsorb both chlorophyll and other components without chlorophyll reoccurring in the unripe essential oil or the other components recovered from the activated carbon.

The treated essential oils or the components of the treated essential oil are preserved by drying, cooling, or freezing for subsequent use or are immediately added to other compositions, e.g., drinks, foods, perfumes, medications, or the like. The components of the essential oil composition can be further prepared or treated, for example, by concentration, separation, or purification (if more than one component is present).

The present invention is further illustrated below in an example which is not to be construed in any way as imposing limitations upon the scope of the invention. On the contrary, it is to be clearly understood that resort may be had to various other embodiments, modifications, and equivalents thereof which, after reading the description therein, may suggest themselves to those skilled in the art without departing from the scope of the invention and the appended claims.

### Example 1

Beverage samples were made with four different batches of unripe mandarin oil (Batches 1-4) and two different batches of ripe mandarin oil (Batches 5-6) sourced from various parts of the world. None of the mandarin oils has been treated with activated carbon or any other adsorbent material. For each batch of oil, two identical beverage samples were made but one was stored under ambient temperature with continuous exposure to artificial light emitted from fluorescent lamps, except for brief periods when the lamps were turned off (sample a), and the other was stored under ambient temperature with no exposure to light (sample b). Table 1 shows the Conversion Rate and PC/GT Ratio of each sample at day 2, day 5, day 15, day 22, and day 25.

TABLE 1
PC/GT Ratio and Conversion Rate of
Beverages Made with Untreated Mandarin Oils

| | | Light | PC/GT Ratio | | | | | Conversion |
|---|---|---|---|---|---|---|---|---|
| # | Type of Oil | Conditions | Day 2 | Day 5 | Day 15 | Day 22 | Day 25 | Rate |
| 1a | Unripe Oil | Light | 0.119 | 0.199 | 0.612 | 1.201 | 1.566 | 13.160 |
| | (batch #1) | | | | | | | |
| 1b | Unripe Oil | No Light | 0.086 | 0.093 | 0.116 | 0.120 | 0.118 | 1.372 |
| | (batch #1) | | | | | | | |
| 2a | Unripe Oil | Light | 0.121 | 0.246 | 0.923 | 1.518 | 2.2 | 18.182 |
| | (batch #2) | | | | | | | |
| 2b | Unripe Oil | No Light | 0.075 | 0.081 | 0.099 | 0.108 | 0.11 | 1.467 |
| | (batch #2) | | | | | | | |
| 3a | Unripe Oil | Light | 0.118 | 0.153 | 0.275 | 0.368 | 0.445 | 3.771 |
| | (batch #3) | | | | | | | |
| 3b | Unripe Oil | No Light | 0.097 | 0.096 | 0.100 | 0.101 | 0.102 | 1.052 |
| | (batch #3) | | | | | | | |
| 4a | Unripe Oil | Light | 0.114 | 0.152 | 0.268 | 0.405 | 0.530 | 4.649 |
| | (batch #4) | | | | | | | |
| 4b | Unripe Oil | No Light | 0.089 | 0.089 | 0.091 | 0.093 | 0.094 | 1.056 |
| | (batch #4) | | | | | | | |
| 5a | Ripe Oil | Light | 0.078 | 0.083 | 0.089 | 0.090 | 0.101 | 1.295 |
| | (batch #5) | | | | | | | |
| 5b | Ripe Oil | No Light | 0.081 | 0.081 | 0.083 | 0.086 | 0.088 | 1.086 |
| | (batch #5) | | | | | | | |
| 6a | Ripe Oil | Light | 0.075 | 0.078 | 0.086 | 0.094 | 0.094 | 1.253 |
| | (batch #6) | | | | | | | |
| 6b | Ripe Oil | No Light | 0.074 | 0.074 | 0.075 | 0.077 | 0.077 | 1.041 |
| | (batch #6) | | | | | | | |

Samples 1 to 4 reveal that beverages utilizing unripe mandarin oils had Conversion Rates greater than 3.0 when they were stored under light while identical samples stored without exposure to light had Conversion Rates less than 2.0. Depending on the batch of unripe mandarin oil, the content of the chlorophyll varies and thus the Conversion Rate when stored under light also varies. Samples 5 to 6 show that beverages utilizing ripe mandarin oils had similar Conversion Rates regardless of whether the sample were or were not exposed to light during storage. The results demonstrate that while light is a crucial factor in the Conversion Rates of beverages containing unripe mandarin oils, which are tied to the tastes and odors of the beverages, light does not play a significant role for beverages containing ripe mandarin oils.

### Example 2

One batch of unripe mandarin oil was divided into five portions. Each portion of the oil was contacted with a different amount of activated carbon (5 to 11 weight % of the mandarin oil). Two identical beverage samples were made from each portion and one stored under ambient temperature with continuous exposure to artificial light emitted from fluorescent lamps, except for brief periods when the lamps were turned off (sample a), and the other stored under ambient temperature with no exposure to light (sample b). Table 2 shows the Conversion Rate and PC/GT Ratio of each sample at day 2, day 5, day 15, day 22, and day 25.

TABLE 2
PC/GT Ratio and Conversion Rate of Beverages Made with
Treated Mandarin Oils at Varying Amount of Activated Carbon

| | Amount of | Light | PC/GT Ratio | | | | | Conversion |
|---|---|---|---|---|---|---|---|---|
| # | Carbon | Conditions | Day 2 | Day 5 | Day 15 | Day 20 | Day 25 | Rate |
| 1a | 5 wt % | Light | 0.109 | 0.115 | 0.145 | 0.162 | 0.176 | 1.615 |
| 1b | 5 wt % | No Light | 0.106 | 0.109 | 0.111 | 0.115 | 0.116 | 1.094 |
| 2a | 7 wt % | Light | 0.108 | 0.115 | 0.136 | 0.144 | 0.149 | 1.380 |
| 2b | 7 wt % | No Light | 0.104 | 0.109 | 0.111 | 0.114 | 0.117 | 1.125 |
| 3a | 9 wt % | Light | 0.107 | 0.110 | 0.124 | 0.132 | 0.142 | 1.327 |
| 3b | 9 wt % | No Light | 0.106 | 0.108 | 0.109 | 0.110 | 0.112 | 1.057 |
| 4a | 10 wt % | Light | 0.087 | 0.091 | 0.107 | 0.121 | 0.129 | 1.483 |
| 4b | 10 wt % | No Light | 0.084 | 0.086 | 0.088 | 0.090 | 0.092 | 1.095 |
| 5a | 11 wt % | Light | 0.109 | 0.114 | 0.127 | 0.136 | 0.141 | 1.294 |
| 5b | 11 wt % | No Light | 0.108 | 0.108 | 0.112 | 0.114 | 0.116 | 1.074 |

Table 2 shows that the Conversion Rates of unripe mandarin oil treated with at least 5 wt % of activated carbon are lower than 2.0, regardless of whether the samples were stored with or without exposure to light. Compared with Table 1, the Conversion Rates of samples containing the treated unripe mandarin oils are significantly lower than the Conversion Rates of samples containing untreated unripe mandarin oils. Furthermore, the Conversion Rates of samples containing the treated unripe mandarin oils are similar to the Conversion Rates of samples containing the ripe mandarin oils. Hence, the treated unripe mandarin oils can be a viable substitute for the more expensive ripe mandarin oils in many products without affecting the organoleptic properties of the products.

Table 2 also shows that the higher the amount of activated carbon used, the lower the Conversion Rate. Depending on the applications, one skilled in the art may readily adjust the amount of activated carbon for contacting the unripe essential oil to produce a treated essential oil suitable for the application.

It should be understood that the foregoing relates to particular embodiments of the present invention and that numerous changes may be made therein without departing from the scope of the invention as defined by the following claims.

The compositions, apparatus, and methods of the appended claims are not limited in scope by the specific compositions, apparatus, methods, and examples described herein, which are intended as illustrations of a few aspects of the compositions, apparatus, and methods of the claims and any compositions, apparatus, and methods which are functionally equivalent are within the scope of this disclosure. Various modifications of the compositions, apparatus, and methods in addition to those shown and described herein will become apparent to those skilled in the art and are intended to fall within the scope of the appended claims. Further, while only certain representative combinations of the compositions, apparatus, and of the method steps disclosed herein are specifically described, other combinations of the apparatus components and method steps will become apparent to those skilled in the art and also are intended to fall within the scope of the appended claims. Thus a combination of components or steps may be explicitly mentioned herein; however, all other combinations of components and steps are included, even though not explicitly stated. The term comprising and variations thereof as used herein is used synonymously with the term including and variations thereof and are open, non-limiting terms.

What is claimed is:

1. A method of enhancing the stability and usability of an unripe essential oil without substantially changing an organoleptic property other than color of the unripe essential oil comprising:
obtaining an unripe essential oil derived from a plant source, wherein the unripe essential oil comprises a first amount of chlorophyll;
contacting the unripe essential oil with an effective amount of an activated carbon to produce a treated essential oil; and
separating the activated carbon from the treated essential oil.

2. The method of claim 1, wherein the treated essential oil comprises a second amount of chlorophyll that is less than the first amount of chlorophyll.

3. The method of claim 1, wherein the treated essential oil may be substantially free of chlorophyll.

4. The method of claim 1, wherein the effective amount of the activated carbon is at least a minimum, wherein the minimum is the lowest amount necessary to make the shelf life of the treated essential oil similar to the shelf life of a ripe essential oil derived from the plant source.

5. The method of claim 1, wherein the effective amount of the activated carbon is less than a maximum, wherein the maximum is the amount beyond which the activated carbon adsorbs more of the unripe essential oil and/or a desirable component than the first amount of chlorophyll.

6. The method of claim 1, wherein the effective amount of the activated carbon is less than a maximum, wherein the maximum is the amount necessary to remove at least about 70% of the first amount of chlorophyll.

7. The method of claim 1, wherein the unripe essential oil is a citrus oil.

8. The method of claim 7, wherein the citrus oil is a mandarin oil.

9. The method of claim 8, wherein the effective amount of the activated carbon is at least 5 wt % of the mandarin oil.

10. A first edible product comprising the treated essential oil of claim 1.

11. The first edible product of claim 10, wherein the first edible product comprises a shelf life similar to the shelf life of a second edible product comprising a ripe essential oil derived from the plant source.

12. A method for extending the shelf life of a first edible product comprising an unripe essential oil, comprising:
obtaining an unripe essential oil derived from a plant source, wherein the Conversion Rate of the unripe essential oil is at least about 3.0;
contacting the unripe essential oil with an effective amount of an activated carbon to produce a treated essential oil, wherein the Conversion Rate of the treated essential oil is less than about 2.5;
separating the activated carbon from the treated essential oil; and
utilizing the treated essential oil in the first edible product.

13. The method of claim 12, wherein the Conversion Rate of the treated unripe essential oil is less than about 2.0.

14. The method of claim 12, wherein the Conversion Rate of the first edible product is similar to the Conversion Rate of a second edible product comprising a ripe essential oil derived from the plant source.

15. A method for extracting a component from an unripe essential oil comprising:
obtaining an unripe essential oil, wherein the unripe essential oil comprises at least one component selected from a chlorophyll, a flavonoid, and a desirable component;
contacting the unripe essential oil with an effective amount of an activated carbon to produce a treated essential oil, wherein the at least one component is adsorbed by the activated carbon; and
separating the activated carbon from the treated essential oil.

16. The method of claim 15, wherein the at least one component is a flavonoid and the method further comprising recovering the flavonoid from the activated carbon with a polar solvent.

17. The method of claim 16, wherein the polar solvent is selected from an acetone, an ethanol, and a dichloromethane.

18. The method of claim 16, further comprising washing the activated carbon with a nonpolar solvent prior to recovering the flavonoid from the activated carbon.

19. The method of claim 16, wherein the at least one component is a desirable component.

20. The method of claim 19, wherein the effective amount of the activated carbon is less than a maximum, wherein the maximum is the amount necessary to remove a threshold amount of the desirable component.
